(19) United States
(12) Patent Application Publication
(10) Pub. No.: US 2022/0113539 A1
(43) Pub. Date: Apr. 14, 2022

(54) WINDSHIELD DISPLAY DEVICE

(71) Applicant: DENSO CORPORATION, Kariya-city (JP)

(72) Inventor: Hirotaka KOYAMA, Kariya-city (JP)

(21) Appl. No.: 17/559,420

(22) Filed: Dec. 22, 2021

Related U.S. Application Data
(63) Continuation of application No. PCT/JP2020/026554, filed on Jul. 7, 2020.

(30) Foreign Application Priority Data
Jul. 18, 2019 (JP) 2019-133113

(51) Int. Cl. G02B 27/01; G03B 21/56; B60K 35/00

(52) U.S. Cl. CPC G02B 27/0101; B60K 2370/1529; B60K 35/00; G03B 21/56

(57) ABSTRACT

A windshield display device that allows an occupant to visually recognize an image through a windshield of a vehicle includes a transparent screen arranged on the windshield and a projector configured to project an image light on the transparent screen. The projector is arranged in an end adjacent portion of a passenger compartment of the vehicle adjacent to the end of the windshield in a vehicle width direction, and projects the image light on an area equal to or larger than a predetermined area in the vehicle width direction of the windshield. The transparent screen transmits an outside light from an outside of the vehicle into a passenger compartment, and transmits the image light to an eye box of a first occupant seated in a driver's seat of the vehicle, to an eye box of a second occupant seated in a passenger seat, or to both eye boxes thereof.

### CROSS REFERENCE TO RELATED APPLICATIONS

This application is a continuation application of International Patent Application No. PCT/JP2020/026554 filed on Jul. 7, 2020, which designated the U.S. and based on and claims the benefits of priority of Japanese Patent Application No. 2019-133113 filed on Jul. 18, 2019. The entire disclosure of all of the above applications is incorporated herein by reference.

### TECHNICAL FIELD

The present disclosure relates to a windshield display device.

### BACKGROUND

Conventionally, a head-up display device projects an image light onto a transparent plate-shaped member provided on a moving body such as an automobile so that an occupant can visually recognize an image by superimposing it on the scenery in front of the transparent plate-shaped member. Hereinafter, the head-up display device will be referred to as a “HUD device”.

According to the windshield display device of the present disclosure, the image is visually recognized by a driver or the like via the windshield.

According to one aspect of the present disclosure, a windshield display device that allows an occupant to visually recognize an image through a windshield of a vehicle includes a transparent screen arranged on the windshield and a projector configured to project image light on the transparent screen. The projector is arranged in a passenger compartment of the vehicle adjacent to an end of the windshield in a vehicle width direction, and projects an image light on an area equal to or larger than a predetermined area of the windshield in the vehicle width direction. The transparent screen transmits an outside light from the outside of the vehicle into the passenger compartment and allows the image light to be transmitted to an eye box of a first occupant seated in a driver's seat of the vehicle, to an eye box of a second occupant seated in a passenger seat, or to both eye boxes.

### BRIEF DESCRIPTION OF THE DRAWINGS

FIG. 1 is a diagram showing a vehicle equipped with a windshield display device of a first embodiment;

FIG. 2 is an explanatory diagram for explaining an arrangement example of components of the windshield display device of FIG. 1;

FIG. 3 is an explanatory diagram for explaining an incident angle and a reflection angle when light is irradiated from a projector to a transparent screen, and a transmission of outside light from an outside of a passenger compartment to an interior of the passenger compartment;

FIG. 4 is a graph showing an example of a relationship between an incident angle and a reflection angle on a transparent screen;

FIG. 5 is a diagram showing a windshield display device according to a second embodiment;

FIG. 6 is a diagram showing a windshield display device according to a third embodiment;

FIG. 7 is a diagram showing a windshield display device according to a fourth embodiment;

FIG. 8 is a plan view showing a configuration example of a transparent screen in the windshield display device of FIG. 7;

FIG. 9 is a plan view showing another configuration example of the transparent screen in the windshield display device of FIG. 7;

FIG. 10 is a plan view showing an arrangement example of a transparent screen in another embodiment; and

FIG. 11 is a plan view showing another arrangement example of a transparent screen in another embodiment.

### DETAILED DESCRIPTION

In an assumable example, a head-up display device projects image light onto a transparent plate-shaped member provided on a moving body such as an automobile so that an occupant can visually recognize an image by superimposing it on the scenery in front of the transparent plate-shaped member. Hereinafter, the head-up display device will be referred to as a “HUD device”.

The HUD device includes an image display unit, an illumination unit that illuminates the image display unit from a back side, a plane mirror that reflects light projected from the illumination unit via the image display unit, and a concave mirror that reflects the light from the plane mirror and projects it onto the windshield. This HUD device magnifies the image displayed on the image display unit with the concave mirror and projects it onto the windshield, displays the magnified image as a virtual image in a space in front of the windshield, and makes the driver or the like recognize the virtual image. This HUD device is mounted in a dashboard and emits light from the dashboard toward the windshield. The light emitted from the HUD device reaches a driver's eye box after being reflected by the windshield.

In recent years, in the field of a display device that allows a driver to recognize various images via the windshield, such as the above-mentioned HUD device, there is a need to increase the display area of an image.

However, in the above-mentioned HUD device, the display area of the image to be visually recognized by the user is limited to a part of the windshield located in front of the user. If the image is displayed in a predetermined or larger area that is wider than a conventional area of the windshield by this HUD device, the light source and the concave mirror must be enlarged in order to widen the area for projecting the image light, and the HUD device itself becomes large.

According to the windshield display device of the present disclosure, the image is visually recognized by a driver or the like via the windshield, and the image can be visually recognized in a predetermined area or more of the windshield while suppressing an increase in the size of a light source.

According to one aspect of the present disclosure, a windshield display device that allows an occupant to visually recognize an image through a windshield of a vehicle includes a transparent screen arranged on the windshield and a projector configured to project image light on the transparent screen. The projector is arranged in a passenger compartment of the vehicle adjacent to an end of the windshield in a vehicle width direction, and projects an image light on an area equal to or larger than a predetermined area of the windshield in the vehicle width direction. The transparent screen transmits an outside light from the outside of the vehicle into the passenger compartment and allows the image light to be transmitted to an eye box of a first occupant seated in a driver's seat of the vehicle, to an eye box of a second occupant seated in a passenger seat, or to both eye boxes.

As a result, the windshield display device projects the image light on the transparent screen superimposed on the windshield from the projector mounted on the end adjacent portion adjacent to the end of the windshield in the vehicle width direction. In such a configuration, the transparent screen reflects the image light toward the driver's seat, the passenger's seat or both seats so that the occupant seated in the driver's seat, or the occupant seated in the passenger seat, or both occupants can visually recognize the image.

By arranging the projector adjacent to the end of the vehicle, it is possible to project the image light over a predetermined area or more of the transparent screen superimposed on the windshield, and it is possible to suppress the increase in size of a light source. Further, the transparent screen reflects the image light to allow the occupant to visually recognize the image, so that the occupant can visually recognize the image in a wider area than the conventional HUD device at a position of the windshield.

Therefore, in the windshield display device, the image can be visually recognized by the occupant in a predetermined area or more in a wider range than the conventional HUD device in the windshield while suppressing the increase in size of the light source.

Hereinafter, embodiments of the present disclosure will be described with reference to the drawings. In the following embodiments, the same reference numerals are assigned to parts that are the same or equivalent to each other to describe the same.

### First Embodiment

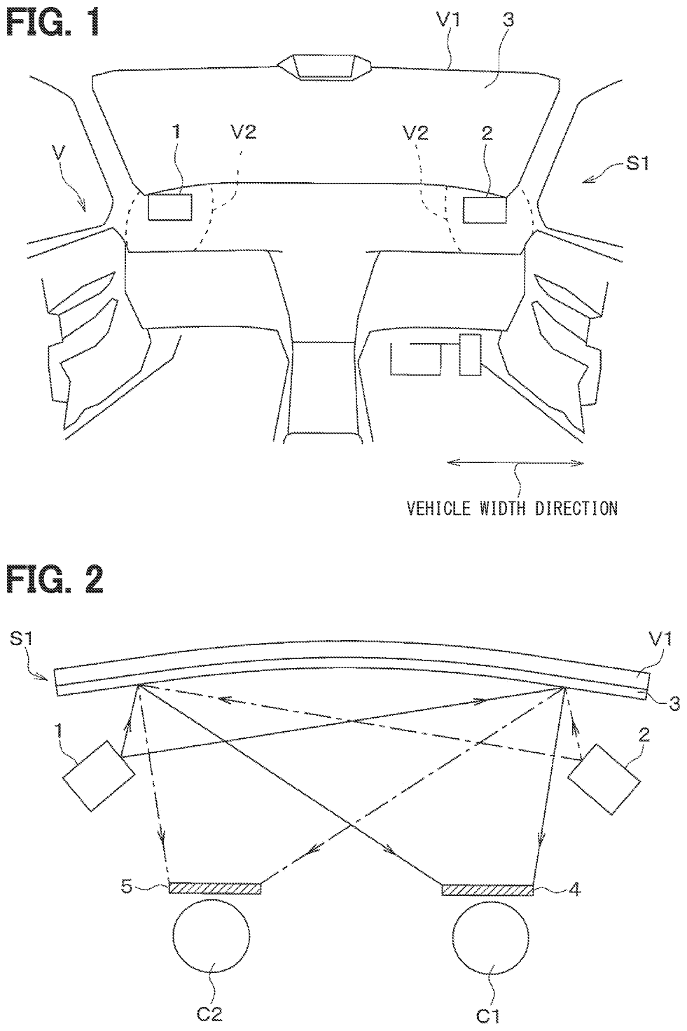

A windshield display device S1 of a first embodiment will be described with reference to FIGS. 1 to 4.

In FIG. 1, a steering of a vehicle V and the like are omitted in order to make it easier to see the mounting locations of the projectors 1 and 2 described later. In FIG. 2, in order to make it easier to see and to assist understanding, an image light from a first projector 1 described later and its reflected light are shown by solid lines, and an image light from a second projector 2 described later and its reflected light are shown by a single point chain line, and arrows are attached to a direction of each image light and reflected light.

Hereinafter, for convenience of explanation, the left-right direction of the paper surface indicated by an arrow in FIG. 1 is referred to as a “vehicle width direction” in the vehicle V.

As shown in FIG. 1, for example, the windshield display device S1 of the present embodiment is mounted on a vehicle V such as an automobile, projects light from projectors 1 and 2 toward a windshield V1, and causes a driver or the like to visually recognize various images via the windshield V1.

A meaning of “causes a driver or the like to visually recognize various images via the windshield V1” is that the image light is projected onto a transparent screen 3 from the first projector 1, the second projector 2, or both of projectors, and the image light is reflected so that the user can visually recognize various images.

The projectors 1 and 2 are arbitrary light sources used for projecting image light onto the transparent screen 3 so that the user can visually recognize various images as real images at a position of the windshield V1. The projectors 1 and 2 may be any projector such as a liquid crystal display system, a DLP (registered trademark) system, or a laser light scanning system. DLP is an abbreviation for digital lighting processing. The projectors 1 and 2 are connected to, for example, another vehicle-mounted device (not shown), and project the image light corresponding to the image signal based on the image signal corresponding to various images such as on the display screen of the other vehicle-mounted device. Other in-vehicle devices may be, for example, various other electronic devices such as a navigation device, an in-vehicle camera, and a car air conditioner, but are not limited thereto. Since this type of projector is well known, detailed description thereof will be omitted in the present specification.

The projectors 1 and 2 are arranged at positions where image light can be projected on an area equal to or larger than the predetermined area of the windshield V1. Specifically, the projectors 1 and 2 are arranged in an end adjacent portion V2, which is a part area of the vehicle V adjacent to the end of the windshield V1 in the vehicle width direction.

A meaning of “area equal to or larger than the predetermined area of the windshield V1” is a area wider than the area where the virtual image is displayed by the conventional HUD device, that is, a predetermined area of the windshield V1 located in front of the driver's seat. For example, as shown in FIG. 2, the wider area of the windshield V1 from a predetermined area located in front of the driver's seat of the vehicle V to a predetermined area located in front of the passenger seat of the vehicle V corresponds to “the area equal to or larger than a predetermined area of the windshield V1”.

Further, as the end adjacent portion V2, for example, as shown in FIG. 1, a part area of the dashboard including the end in the vehicle width direction and the like is defined. In the present embodiment, an example in which the end adjacent portion V2 is the area of the end of the dashboard in the vehicle direction will be described as a typical example.

Hereinafter, for the sake of simplification of the description, the occupant C1 seated in a driver's seat of the vehicle V will be referred to as a “first occupant C1”, and the occupant C2 seated in a passenger seat of the vehicle V will be referred to as a “second occupant C2”. Further, an eye box 4 of the first occupant C1 is referred to as a “first eye box 4”, and an eye box 5 of the second occupant C2 is referred to as a “second eye box 5”. Further, for convenience of explanation, a direction from the driver's seat side to the passenger's seat side in the vehicle width direction of the vehicle V is referred to as a “first direction”, and the opposite direction is referred to as a “second direction”.

As shown in FIG. 1, the first projector 1 is mounted in a predetermined area of the end adjacent portion V2 of the vehicle V on the passenger seat side, that is, on the end on the first direction side of the dashboard. The image light projected from the first projector 1 onto the transparent screen 3 is reflected in the first eye box 4, which is a rectangular area assumed as the position of the eyes of the first occupant C1 seated in the driver's seat of the vehicle V, and the driver recognizes visually as various images in the driver's seat. In other words, the first projector 1 is a projector for displaying an image on the first occupant C1 by projecting image light onto the transparent screen 3 from diagonally forward and allowing the first occupant C1 to visually recognize the image.

The second projector 2 is mounted in a predetermined area of the end adjacent portion V2 of the vehicle V on the driver's seat side, that is, on the end on the second direction side of the dashboard. The image light projected from the second projector 2 onto the transparent screen 3 is reflected in the second eye box 5, which is a rectangular area assumed as the position of the eyes of the second occupant C2 seated in the passenger seat of the vehicle V, and the driver recognizes visually as various images in the driver's seat. That is, the second projector 2 is a projector for displaying an image to the second occupant C2 by projecting the image light diagonally from the front onto the transparent screen 3 and allowing the second occupant C1 to visually recognize the image.

The transparent screen 3 is superposed on a part area or all area of the windshield V1 via an arbitrary transparent adhesive such as PVB (polyvinyl butyral) resin. As shown in FIG. 2, for example, the transparent screen 3 reflects the image light projected from the first projector 1 on the first eye box 4, and reflects the image light projected from the second projector 2 on the second eye box 5.

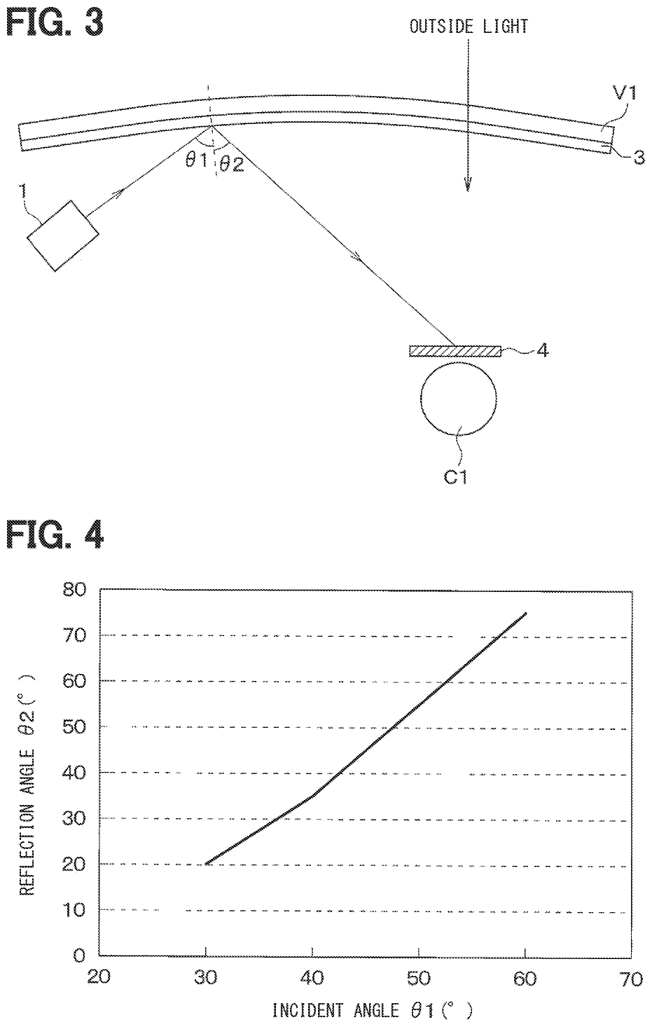

Specifically, the transparent screen 3 is an optical member, and can reflect only light incident in a specific angle range at a specific reflection angle corresponding to the incident angle, and simply reflects light incident at other angles. For example, as shown in FIG. 3, the angle of the image light incident on the transparent screen 3 from the first projector 1 is defined as an incident angle θ1, and the angle reflected toward the first occupant C1 is defined as a reflection angle θ2. Specifically, the incident angle 81 is an angle formed between the normal line of the surface formed by the transparent screen 3 with respect to the surface at the point where the incident light is irradiated and the incident light. The reflection angle θ2 is an angle formed by the normal line with respect to the surface at the point where the incident light incident at the incident angle θ1 is applied to the surface formed by the transparent screen 3 and the reflected light reflected from the incident light.

At this time, as shown in FIG. 4, for example, the transparent screen 3 is configured to reflect the incident light at a reflection angle θ2 according to the incident angle θ1 so that the reflection angle θ2 becomes 20°, 35°, 55°, and 75°, respectively when the incident angle θ1 is 30°, 40°, 50°, and 60°. A relationship between the incident angle θ1 and the reflection angle θ2 is appropriately changed depending on the arrangement of the image light projection ports of the projectors 1 and 2, the transparent screens 3 and the eye boxes 4 and 5, the curvature of the windshield V1 and the like.

As shown in FIG. 3, for convenience, the incident angle θ1 in FIG. 4 is set to a positive value when the incident light is on the left side of the paper surface with respect to the normal, and the reflection angle θ2 is set to a positive value when the reflected angle is on the right side of the paper surface with respect to the normal. Therefore, the reflection angle θ2 can be a negative value in a part of the transparent screen 3. Specifically, for example, in the example of FIG. 3, the image light from the first projector 1 is incident on the area on the right side of the paper surface of the transparent screen 3 in front of the first eye box 4. Then, when the reflected light is incident on the first eye box 4, the reflection angle θ2 becomes the negative value. At this time, it is necessary to reflect the reflected light to the left side of the paper surface from the normal line, and according to the above definition, the reflection angle θ2 is a negative value. Further, in FIGS. 3 and 4, the case where the image light of the first projector 1 is reflected toward the first eye box 4 has been described as an example. When the image light from the second projector 2 is reflected toward the second eye box 5, the transparent screen 3 is designed based on the same idea.

The transparent screen 3 is, for example, an optical film having a microlens array in which a plurality of microlenses having a convex elliptical hemisphere shape (not shown) are repeatedly arranged so as to be convex toward the passenger compartment side. As shown in FIG. 3, the transparent screen 3 reflects light incident from the passenger compartment side at a predetermined angle, while transmitting outside light from the outside of the passenger compartment into the passenger compartment.

As shown in FIG. 2, the transparent screen 3 reflects the image light from the first projector 1 to the first eye box 4 and reflects the image light from the second projector 2 to the second eye box 5. In other words, the transparent screen 3 functions as a screen for displaying a common real image of the projectors 1 and 2 in the present embodiment.

In this case, when the windshield V1 has a symmetrical shape in the vehicle width direction, each microlens has, for example, a symmetrical shape and is arranged so that the symmetrical direction is along the vehicle width direction. Further, at this time, in the microlens array composed of the microlenses, for example, an axis of symmetry thereof is arranged so as to overlap the axis of symmetry of the windshield V1 in the plane direction of the windshield V1 and in the direction orthogonal to the vehicle width direction. As a result, the transparent screen 3 has a distribution in which the optical characteristics of the incident angle θ1 and the reflection angle θ2 as shown in FIG. 4 are symmetrical in the vehicle width direction, and has a configuration in which image light projected from different positions can be reflected on different eye boxes 4 and 5, respectively, as shown in FIG. 2.

As a result, the transparent screen 3 transmits the outside light from the front of the windshield V1 and reflects the image light incident from a predetermined angle to the first eye box 4 or the second eye box 5. The transparent screen 3 can both secure a filed of view of the outside world and display the image. As the transparent screen 3, for example, a Lumisty (Registered Trademark) film manufactured by Sumitomo Chemical Co., Ltd. can be used.

The above is the basic configuration of the windshield display device S1 of the present embodiment. With such a configuration, the following effects can be obtained.

The projectors 1 and 2 are arranged in the end adjacent portion V2 of the vehicle V adjacent to the end of the transparent screen 3 in the vehicle width direction, and it is possible to project the image light over a wider area than the conventional HUD device, and it is possible to suppress the increase in size of the projectors 1 and 2. Further, by reflecting the image light projected on the wide area by the transparent screen 3 on the first eye box 4 or the second eye box 5, the occupants C1 and C2 can visually recognize the image on the windshield V1 in the wider area than before.

Further, by using the transparent screen 3 in which the reflection angle of the light incident in a specific angle range is adjusted, the reflectance for the light incident from a predetermined angle is higher than the reflectance when a commonly used transparent light diffusing plate is used. As a result, the output of the light sources of the projectors 1 and 2 can be made lower than that in the case of using the normal transparent light diffusing plate, and the brightness of the image can be equal to or higher than that in the case of using the normal transparent light diffusing plate. Therefore, the windshield display device S1 has the effect of reducing the heat load of the projectors 1 and 2 while ensuring the brightness of the image.

According to the present embodiment, the windshield display device S1 suppresses the increase in size of the light source for projecting the image light, and allows the first occupant C1 and the second occupant C2 to visually recognize the image in a predetermined area or more of the windshield V1.

### Second Embodiment

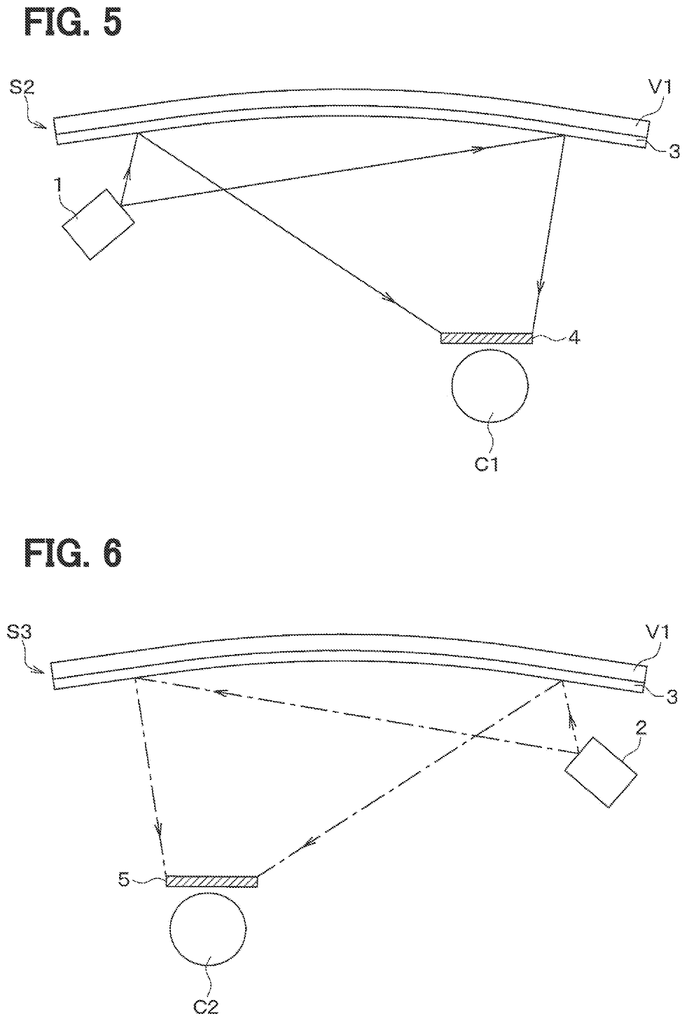

The windshield display device S2 of a second embodiment will be described with reference to FIG. 5. In FIG. 5, similarly to FIG. 2, the image light from the first projector 1 and the reflected light thereof are shown by solid lines, and arrows are attached to their directions.

The windshield display device S2 of the present embodiment has only the first projector 1 as a projector for displaying a real image, and reflects the image light from the first projector 1 to the first eye box 4 of the first occupant C1. This structure is different from the first embodiment. That is, the windshield display device S2 is configured to allow only the first occupant C1 to visually recognize various images at the position of the windshield V1.

Also in the present embodiment, the windshield display device S2 suppresses the increase in size of the light source for projecting the image light, and allows the first occupant C1 to visually recognize the image in a predetermined area or more of the windshield

### Third Embodiment

The windshield display device S3 of a third embodiment will be described with reference to FIG. 6. In FIG. 6, similarly to FIG. 2, the image light from the second projector 2 and the reflected light thereof are shown by an alternate long and short dash line, and arrows are attached to their directions.

The windshield display device S3 of the present embodiment has only the second projector 2 as a projector for displaying a real image, and reflects the image light from the second projector 2 to the second eye box 5 of the second occupant C2. This structure differs from the first embodiment. That is, the windshield display device S3 is configured to allow only the second occupant C2 to visually recognize various images at the position of the windshield V1.

Also in the present embodiment, the windshield display device S3 suppresses the increase in size of the light source for projecting the image light, and allows the second occupant C2 to visually recognize the image in a predetermined area or more of the windshield

### Fourth Embodiment

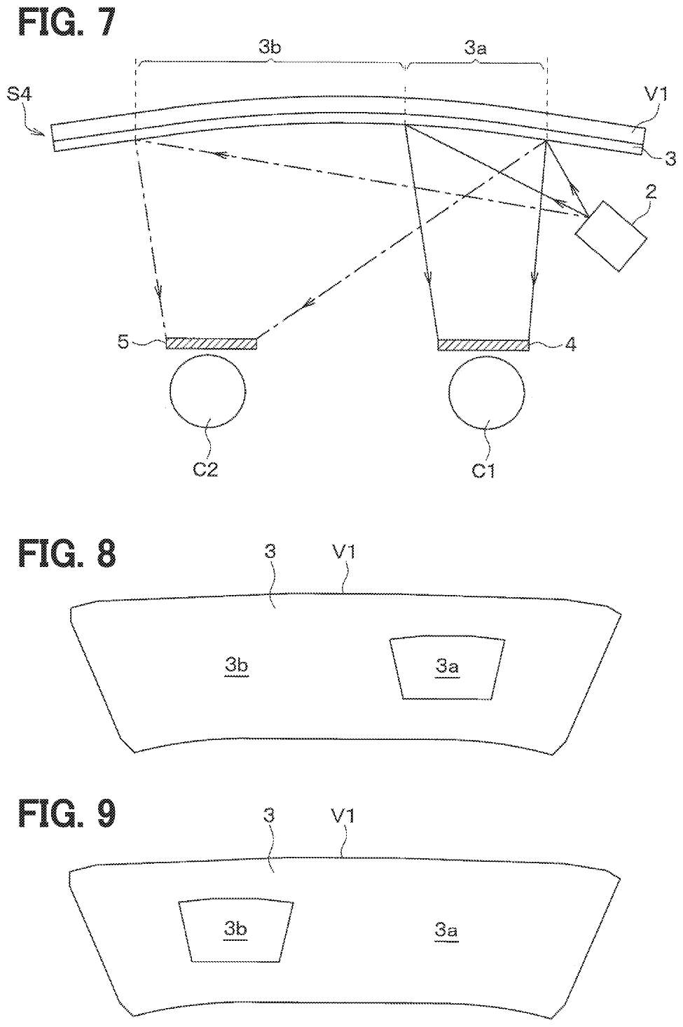

The windshield display device S4 of a fourth embodiment will be described with reference to FIGS. 7 and 8. In FIG. 7, similarly to FIG. 2, the image light from the second projector 2 and the reflected light thereof toward the second eye box 5 are indicated by a dashed line, the reflected light of the image light toward the first eye box 4 is shown by a solid lines, and arrows are attached to their directions.

The windshield display device S4 of the present embodiment has only the second projector 2 as a projector for displaying a real image. In such a configuration, the transparent screen 3 has, for example, as shown in FIG. 7, a first reflecting portion 3a that reflects the image light from the second projector 2 to the first eye box 4, and a second reflecting portion 3b that reflects the image light to the eye box 5. The windshield display device S4 differs from the first embodiment in these respects. This different point will be mainly described in the present embodiment.

As shown in FIG. 8, for example, the transparent screen 3 is arranged so as to be overlapped over the entire area of the windshield V1, and a part of the transparent screen 3 is the first reflecting portion 3a for presenting an image to the first occupant C1. Further, in the transparent screen 3, a portion different from the first reflecting portion 3a is the second reflecting portion 3b for presenting an image to the second occupant C2. That is, the transparent screen 3 is a single optical film having the first reflecting portion 3a and the second reflecting portion 3b, and in the present embodiment, the transparent screen 3 are configured that the first occupant C1 and the second occupant C2 can visually recognize the image by the image light of the second projector 2.

As shown in FIG. 8, for example, the first reflecting portion 3a is surrounded by the second reflecting portion 3b, and its area is smaller than that of the second reflecting portion 3b. The arrangement, area, and the like of the first reflecting portion 3a and the second reflecting portion 3b may be appropriately changed.

According to the present embodiment, it is possible to suppress an increase in the size of the light source for projecting the image light, and the windshield display device S1 allows the second occupant C2 to visually recognize the image in a predetermined area or more of the windshield V1 while also allowing the first occupant C1 to visually recognize the image. Further, in the present embodiment, it is possible for the first occupant C1 and the second occupant C2 to visually recognize different images by one projector.

In the above example, the case where the projector has only the second projector 2 has been described, but the same effect can be obtained even with the configuration having only the first projector 1. In this case, as shown in FIG. 9, for example, the first reflecting portion 3a may have a larger area than the second reflecting portion 3b and may be arranged so as to surround the second reflecting portion 3b.

### Other Embodiments

Although the present disclosure has been described in accordance with the examples, it is understood that the present disclosure is not limited to such examples or structures. The present disclosure also includes various modifications and modifications within an equivalent range. In addition, various combinations and modes, and further, other combinations and modes including one element of these alone, or thereabove, or therebelow, are also comprised within the scope or concept range of the present disclosure.

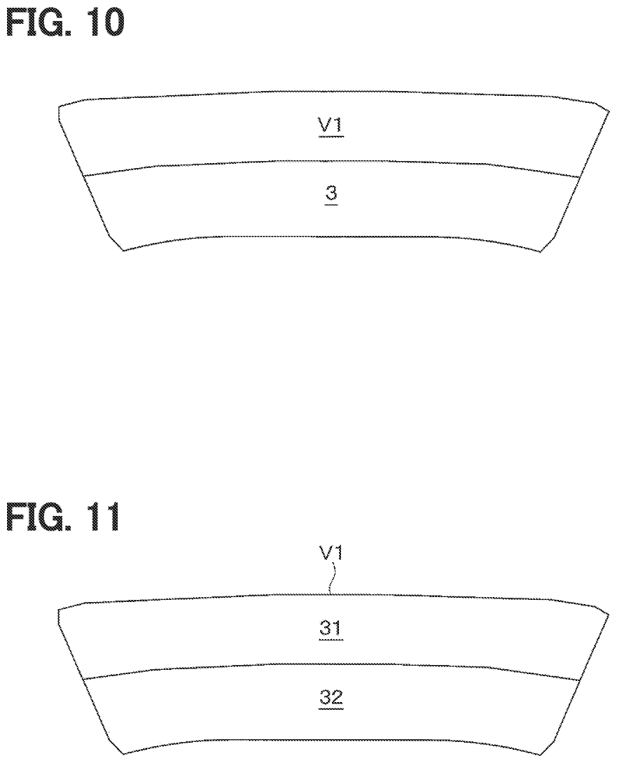

(1) In each of the above embodiments, the case where the transparent screen 3 is arranged in the entire area of the windshield V1 has been described, but the present disclosure is not limited to this configuration. For example, as shown in FIG. 10, the transparent screen 3 may be arranged only in a lower half area of the windshield V1. As a result, in the windshield display device, while securing a predetermined area or more for displaying the image at the position of the windshield V1, the image is not displayed in the area of the windshield V1 where the transparent screen 3 is not arranged, and the field of view of the outside world can be further secured.

The transparent screen 3 is preferably arranged along the direction connecting both ends in the vehicle width direction of the windshield V1, may be arranged only in an upper half of the windshield V1, or is arranged only within a predetermined range in a lower half of the windshield V1. In this way, the transparent screen 3 can be arranged in any area of a part of the windshield V1.

(2) In the first embodiment, an example of projecting image light from projectors 1 and 2 onto a common transparent screen 3 has been described. However, the transparent screen 3 may be composed of two optical films, a first screen 31 and a second screen 32, as shown in FIG. 11, for example. The first screen 31 reflects, for example, the image light from the first projector 1 to the first eye box 4. The second screen 32 reflects, for example, the image light from the second projector 2 to the second eye box 5. As described above, the transparent screen 3 may be composed of a portion corresponding to the first projector 1 and a portion corresponding to the second projector 2.

As a result, the shape and arrangement of the microlens arrays can be different between the first screen 31 and the second screen 32, and the relationship between the incident angle θ1 and the reflection angle θ2 of light, that is, the degree of freedom of the optical characteristics of the transparent screen 3 can be improved. The arrangement of the screens 31 and 32 may be reversed.

(3) In each of the above embodiments, an example in which the end adjacent portion V2 is a part of the dashboard has been described, but the end adjacent portion V2 is not limited to the dashboard as long as the projectors 1 and 2 can project image light onto a predetermined area or more with respect to the windshield V1. The end adjacent portion V2 may be, for example, a pillar adjacent to the end of the windshield V1 in the vehicle width direction of the vehicle V, that is, a so-called A pillar. In this case, the projectors 1 and 2 can project the image light over the entire area of the windshield V1.

(4) In each of the above embodiments, the example in which the transparent screen 3 is arranged on the outer surface of the windshield V1 on the passenger compartment side of the vehicle V has been described. However, the arrangement is not limited to this configuration, as long as the arrangement can reflect the image light to one or both the eye boxes 4 and 5. For example, the transparent screen 3 may be arranged between two glass substrates constituting the windshield V1 via a PVB resin or the like. That is, the phrase “the transparent screen 3 is arranged so as to overlap the windshield V1” in the present specification includes not only the transparent screen 3 being arranged on the outer surface of the windshield V1 but also being arranged inside the windshield V1.

What is claimed is:

1. A windshield display device for allowing an occupant to visually recognize an image via a windshield of a vehicle, the windshield display device comprising:
a transparent screen arranged on the windshield; and
a projector configured to project an image light on the transparent screen, wherein
the projector is arranged in an end adjacent portion of a passenger compartment of the vehicle adjacent to an end of the windshield in a vehicle width direction, and projects the image light on an area equal to or larger than a predetermined area in the vehicle width direction of the windshield,
the transparent screen transmits an outside light from an outside of the vehicle into the passenger compartment, and transmits the image light to an eye box of a first occupant seated in a driver's seat of the vehicle, to an eye box of a second occupant seated in a passenger seat of the vehicle, or to both eye boxes of the first occupant and the second occupant,
the projector is a first projector used to make the first occupant visually recognize the image,
a direction from the driver's seat to the passenger seat in the vehicle width direction is referred to a first direction,
the first projector is arranged at the end adjacent portion adjacent to the end of the windshield in the first direction, and
the transparent screen is a single optical film having a first reflecting portion configured to reflect the image light from the projector to the eye box of the first occupant and a second reflecting portion that is different from the first reflecting portion and reflects the image light to the eye box of the second occupant.

2. A windshield display device for allowing an occupant to visually recognize an image via a windshield of a vehicle, the windshield display device comprising:
a transparent screen arranged on the windshield; and
a projector configured to project an image light on the transparent screen, wherein
the projector is arranged in an end adjacent portion of a passenger compartment of the vehicle adjacent to an end of the windshield in a vehicle width direction, and projects the image light on an area equal to or larger than a predetermined area in the vehicle width direction of the windshield,
the transparent screen transmits an outside light from an outside of the vehicle into the passenger compartment, and transmits the image light to an eye box of a first occupant seated in a driver's seat of the vehicle, to an eye box of a second occupant seated in a passenger seat of the vehicle, or to both eye boxes of the first occupant and the second occupant,
the projector is a second projector used to make the second occupant visually recognize the image,
a direction from the driver's seat to the passenger seat in the vehicle width direction is referred to a first direction, and a direction opposite to the first direction is referred to a second direction, and
the second projector is arranged at the end adjacent portion adjacent to an end of the windshield in the second direction.

3. The windshield display device according to claim 2, wherein
the transparent screen is a single optical film having a first reflecting portion configured to reflect the image light from the projector to the eye box of the first occupant and a second reflecting portion that is different from the first reflecting portion and reflects the image light to the eye box of the second occupant.

4. A windshield display device for allowing an occupant to visually recognize an image via a windshield of a vehicle, the windshield display device comprising:
a transparent screen arranged on the windshield; and
a projector configured to project an image light on the transparent screen, wherein
the projector is arranged in an end adjacent portion of a passenger compartment of the vehicle adjacent to an end of the windshield in a vehicle width direction, and projects the image light on an area equal to or larger than a predetermined area in the vehicle width direction of the windshield,
the transparent screen transmits an outside light from an outside of the vehicle into the passenger compartment, and transmits the image light to an eye box of a first occupant seated in a driver's seat of the vehicle, to an eye box of a second occupant seated in a passenger seat of the vehicle, or to both eye boxes of the first occupant and the second occupant,
the projector includes a first projector used to make the image light visible to the first occupant and a second projector used to make the image light visible to the second occupant,
a direction from the driver's seat to the passenger seat in the vehicle width direction is referred to a first direction, and a direction opposite to the first direction is referred to a second direction,
the first projector is arranged at the end adjacent portion adjacent to an end of the windshield in the first direction, and
the second projector is arranged at the end adjacent portion adjacent to an end of the windshield in the second direction.

5. The windshield display device according to claim 1, wherein
the transparent screen is arranged so as to overlap a part of the area of the windshield.

6. The windshield display device according to claim 1, wherein
the transparent screen is arranged so as to be overlapped over an entire area of the windshield.

7. The windshield display device according to claim 4, wherein
the transparent screen is two optical films configured by a first screen that reflects the image light of the first projector on the eye box of the first occupant, and a second screen that reflects the image light of the second projector on the eye box of the second occupant, and
the first screen is arranged at a position different from that of the second screen.

8. The windshield display device according to claim 1, wherein
the end adjacent portion is part of a dashboard of the vehicle.

9. The windshield display device according to claim 1, wherein
the end adjacent portion is a pillar of the vehicle adjacent to the windshield.
